(19) United States
(12) Patent Application Publication
(10) Pub. No.: US 2014/0154050 A1
(43) Pub. Date: Jun. 5, 2014

(54) HYDROKINETIC UNIT

(71) Applicant: Dan Campeanu, Bucharest (RO)

(72) Inventor: Dan Campeanu, Bucharest (RO)

(73) Assignee: Calin BULTOC, Bucharest (RO)

(21) Appl. No.: 14/123,740

(22) PCT Filed: Jun. 5, 2012
(86) PCT No.: PCT/RO2012/000011

§ 371 Date: Jan. 24, 2014

(30) Foreign Application Priority Data
Jun. 3, 2011 (RO) A 2011 00533

(51) Int. Cl. F03B 17/06

(52) U.S. Cl. CPC F03B 17/06
USPC 415/3.1

(57) ABSTRACT

The invention refers to a hydrokinetic unit which allows a high level exploitation of the energetic potential of rivers in the plain regions, where the flat relief does not allow to build dams or culverts and which is destined to convert the kinetic energy of flowing waters into useful mechanical energy for producing electric energy or for pumping water by using such modular hydrokinetic assemblies equipped with generators or pumps. The hydrokinetic unit according to the invention comprises a threshold (1) of a constant level provided with flaps (2) and two catching connectors (3) with protection grids (4) and, one or more connections (5) with the flaps which regulate the water flow rates necessary for driving the modular hydrokinetic assemblies (6), connected to the catching connector (3) and, which may be equipped with electric generators or water pumping groups.

The invention refers to a hydrokinetic unit which allows a high level exploitation of the energetic potential of rivers in the plain regions, where the flat relief does not allow to build dams or culverts and which is destined to convert the kinetic energy of flowing waters into useful mechanical energy for producing electric energy or for pumping water by using such modular hydrokinetic assemblies equipped with generators or pumps.

In order to exploit the energetic potential of rivers in the plain regions, several solutions called corduroy roads are known, yet with some drawbacks:
they produce mechanical energy only by using common turbines which, in case of rivers in the plain regions, have a low efficiency when compared to modular hydrokinetic assemblies, therefore they manifest a low economic and energetic effectiveness;
in winter time, the water freezes in the hydraulic systems, leading to their arrest and, therefore, their yearly exploiting period is reduced;
with thawing waters, they create ice-floe storage that may damage the hydraulic systems, which implies ice-floe removal operations, with high prime costs given their productive capacity;
they cannot use the entire available flow rate of the rivers they are installed on, therefore they have a low energetic efficiency.

The problem that the invention seeks to solve consists in carrying out a hydrokinetic unit that allows the use of modular hydrokinetic assemblies in order to exploit the energetic potential of rivers in the plain regions at a high level.

The hydrokinetic unit according to the invention removes the above drawbacks in that it is provided with protection against water-freezing on the hydraulic circuit, it provides ice-floe shoving when rivers thaw and it allows the exploitation of the entire available flow rate of the rivers it is installed on.

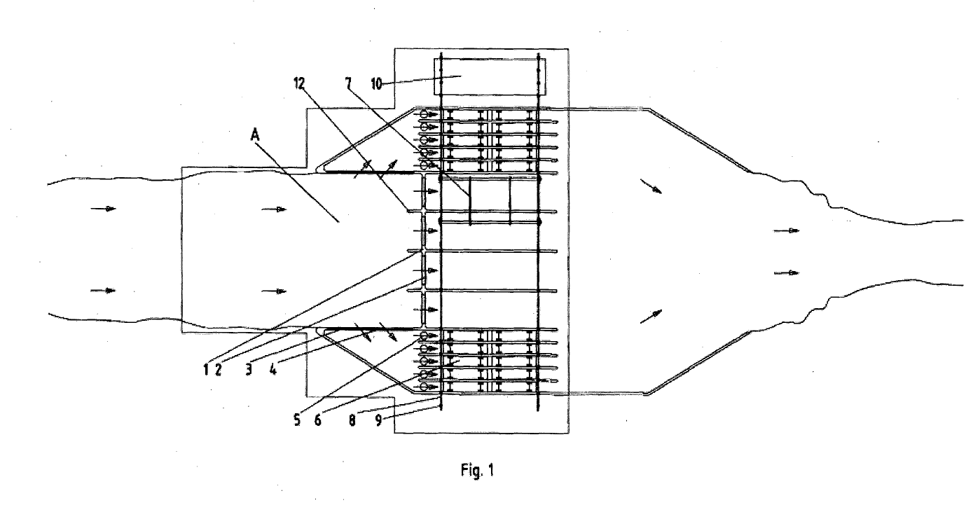

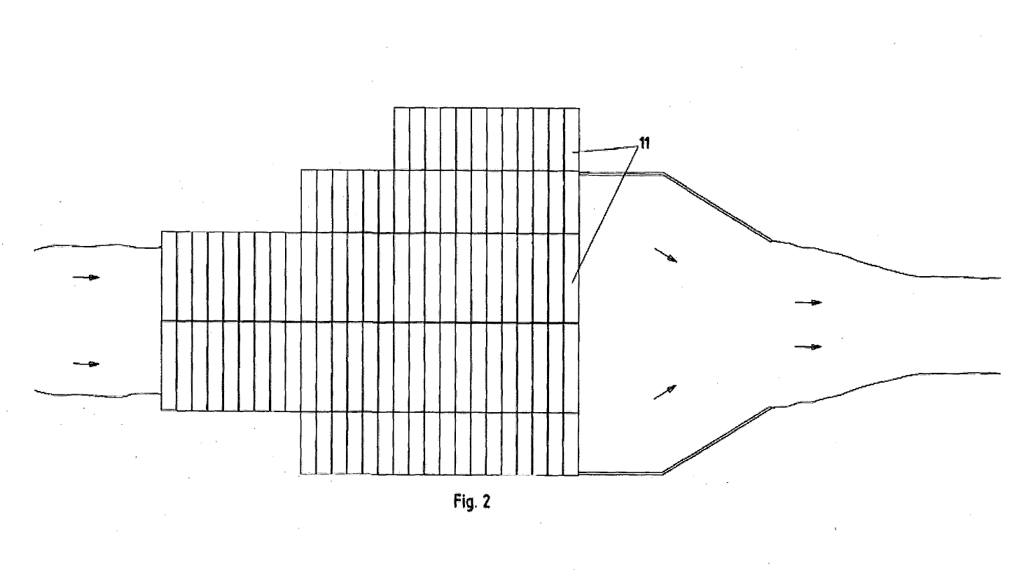

An embodiment example of the invention is given below, in relation with FIGS. 1 and 2, representing:

FIG. 1, a plan view without cover panels;

FIG. 2, a plan view with cover panels.

According to the invention, the hydrokinetic unit comprises a threshold (1) of a constant level provided with flaps (2) and two catching connectors (3) with protection grids (4) and one or more connections (5) with the flaps which regulate the water flow rates necessary for driving the modular hydrokinetic assemblies (6), connected to the catching connector and which may be equipped with electric generators or water pumping groups.

The hydrokinetic unit is provided with a portal crane (7) mounted on the rails (8) supported by posts (9), as well as a plate (10) situated on one of the river margins, for maintenance and repairing activities.

The hydrokinetic unit is covered with translucent and heat insulating panels (11) which produce and maintain a greenhouse effect inside, to render protection against water freezing on winter time, in the unit hydraulic circuit.

The hydrokinetic unit has a channel (A) allowing the downstream to displace ice-floes when the river thaws, by opening said flaps (2) and, for breaking the ice-floes and eliminating ice storage, threshold (1) is provided with cut-offs (12).

The global energetic capacity of a hydrokinetic unit depends mainly on the height of said threshold (1) given which one or more modular hydrokinetic assemblies (6) may be installed, connected one after another and, in relation with the available flow rate of a catching connector (3), given which one or more modular hydrokinetic assemblies (6) may be installed, in parallel.

The hydrokinetic unit according to the invention presents the following advantages:
it allows the effective exploiting of the entire available flow rate of rivers;
being protected against water inrush and freezing in the interior hydraulic circuit, it may function uninterruptedly for the whole year.

1-5. (canceled)

6. A hydrokinetic unit wherein, in order to convert the kinetic energy of flowing waters into mechanical energy, said hydrokinetic unit comprises a threshold (1) of a constant level provided with flaps (2) and two catching connectors (3) which are provided with protection grids (4) against ice floes, and one or more connections (5) which are provided with flaps, which regulate the water flow rates necessary for operating the modular hydrokinetic assemblies (6), connected to the catching connector (3) and which may be equipped with electric generators or water pumping groups, said hydrokinetic unit being covered with translucent and heat insulating panels (11) which produce and maintain a greenhouse effect inside, to render protection against water freezing on winter time in the unit hydraulic circuit.

7. The hydrokinetic unit according to claim 6, wherein, in order to perform the maintenance and repairing activities, it is provided with a portal crane (7) mounted on the rails (8) supported by posts (9), as well as a plate (10) situated on one of the river margins.

8. The hydrokinetic unit according to claim 6, wherein, it has a channel (A) allowing the downstream to displace ice-floes when the river thaws, by opening said flaps (2), while said threshold (1) is provided with cut-offs (12) for breaking the ice-floes and eliminating ice storage.

9. The hydrokinetic unit according to claim 6, wherein, it has an energetic capacity that depends mainly on the height of said threshold (1), given which one or more modular hydrokinetic assemblies (6) may be installed, connected one after another and, in relation with the available flow rate of a catching connector (3), given which one or more modular hydrokinetic assemblies (6) may be installed, in parallel.
